(19) United States
(12) Patent Application Publication
(10) Pub. No.: US 2026/0229610 A1
(43) Pub. Date: Aug. 6, 2026

(54) METHOD FOR MANUFACTURING A DEVICE CASE BODY AND METHOD FOR MANUFACTURING A POWER STORAGE DEVICE

(71) Applicant: Prime Planet Energy & Solutions, Inc., Tokyo (JP)

(72) Inventor: Yozo UCHIDA, Toyota-shi (JP)

(21) Appl. No.: 19/432,113

(22) Filed: Dec. 24, 2025

(30) Foreign Application Priority Data
Feb. 5, 2025 (JP) 2025-017497

(51) Int. Cl. H01M 10/0587; B23K 26/57; B23K 101/38; H01M 50/169

(52) U.S. Cl. CPC H01M 10/0587; B23K 26/57; H01M 50/169; B23K 2101/38

(57) ABSTRACT

A method for manufacturing a tubular device case body made of metal includes inserting an insertion unit of a cutting assist device into a metal tubular member from a leading-end opening of the metal tubular member beyond a ring-shaped to-be-cut portion, cutting the to-be-cut portion by irradiation of a laser beam thereto from outside in a radial direction of the metal tubular member to obtain the device case body, and removing the insertion unit from the metal tubular member with the device case body cut. The insertion unit includes a facing recess, which is recessed to the inside in the radial direction and has a ring-shaped facing opening that faces the to-be-cut portion. The cutting is performed by cutting the metal tubular member while a penetrating laser beam passing through the metal tubular member is received by the facing recess.

### CROSS-REFERENCE TO RELATED APPLICATIONS

This application is based upon and claims the benefit of priority to Japanese Patent Application No. 2025-017497 filed on Feb. 5, 2025, the entire contents of which are incorporated herein by reference.

### BACKGROUND

### Technical Field

The present disclosure relates to a method for manufacturing a device case body and a method for manufacturing a power storage device incorporating the device case body.

### Related Art

As a conventional art for cutting metal plates, a method using a laser beam to cut the plates is known, as disclosed in, for example, Japanese unexamined patent application publication No. 2017-192986 (JP 2017-192986 A).

### SUMMARY

### Technical Problems

However, when a tubular member produced by cutting a long tubular metal material into a ring shape with a laser beam irradiated from outside onto the long tubular metal material is used as a tubular device case body for a power storage device, the inner peripheral surface of the tubular device case body may have damages, such as melt marks caused by the laser beam having penetrated through the device case body. These damages such as melt marks may damage, or scratch, an electrode body when this electrode body is inserted into the device case body.

The present disclosure has been made to address the above problems and has a purpose to provide a method for manufacturing a device case body so that the inside of a manufactured device case body can be suppressed from damages caused by a penetrating laser beam, and a method for manufacturing a power storage device incorporating the thus manufactured device case body.

### Means of Solving the Problems

(1) To achieve the above-mentioned purpose, one aspect of the disclosure provides a method for manufacturing a device case body, which is made of metal in a tubular shape and used for a power storage device, the method comprising: inserting an insertion unit of a cutting assist device into a metal tubular member having a hollow tubular shape extending in an axial direction along an axis of the metal tubular member, through a leading-end opening that opens on a leading end side of the metal tubular member, beyond a to-be-cut portion of the metal tubular member, the to-be-cut portion extending in a ring shape in a circumferential direction around the axis; cutting the to-be-cut portion by irradiating a laser beam from outside in a radial direction of the metal tubular member onto the to-be-cut portion to obtain the device case body; and removing the insertion unit from the metal tubular member after the device case body is cut by cutting the to-be-cut portion, wherein the insertion unit includes a facing recess that is recessed to an inside of the insertion unit in the radial direction and that includes a facing opening extending in a ring shape and facing the to-be-cut portion of the metal tubular member, and in cutting the to-be-cut portion, the metal tubular member is cut while a penetrating laser beam that penetrates through the metal tubular member is received by the facing recess.

In the above-described method for manufacturing the device case body, prior to the process of cutting the metal tubular member by irradiation of a laser beam, the insertion unit of the cutting assist device is inserted into the metal tubular member, so that the laser beam penetrating through the cutting point is received by the facing recess of the insertion unit. Thus, this method can suppress the occurrence of damages, such as melt marks caused by incidence of the penetrating laser beam, on the inner peripheral surface of the device case body (i.e., the metal tubular member) near its opening portions. This can prevent the occurrence of defects, such as damages to an electrode body, when the electrode body is inserted in the device case body. In the present disclosure, the terms “tubular” and “tube” represent a tube-like shape having a cylindrical or prismatic outer shape with a circular or rectangular cross-section.
(2) The method described in (1) may be configured such that the insertion unit includes an air suction passage including an air suction inlet that opens in the facing recess and allowing suction air to flow through, the suction air being sucked from an area around a cutting point via the facing recess and the air suction inlet, while the cutting point is being cut by irradiation of the laser beam, the cutting assist device includes an air suction unit to suck the suction air through the air suction passage of the insertion unit, and in cutting the to-be-cut portion, the metal tubular member is cut while spatter particles occurring from the cutting point are sucked by the air suction unit together with the suction air through the air suction passage.
(3) Furthermore, the method described in (2) may also be configured such that the insertion unit includes a plurality of air passages each including a recess-side opening that opens in the facing recess, the plurality of air passages being to be selectively used as the air suction passage including the air suction inlet, the cutting assist device further includes a switching part configured to switch between the plurality of air passages to select at least one of the air passages used as the air suction passage, and in cutting the to-be-cut portion, the metal tubular member is cut while the switching part switches between the air passages to be used as the air suction passage as the cutting point is moved forward.
(4) The method described in (1) may also be configured such that the insertion unit includes an air supply passage including an air ejection outlet that opens in the facing recess and allowing blowing air to flow through, the blowing air being to be ejected from the air ejection outlet to an outside of the metal tubular member via the facing recess and an area around the cutting point, while the cutting point is being cut by irradiation of the laser beam, the cutting assist device includes an air supply unit to supply the blowing air through the air supply passage of the insertion unit, and in cutting the to-be-cut portion, the metal tubular member is cut while spatter particles occurring from the cutting point are expelled out of the metal tubular member by the blowing air ejected through the air supply passage.
(5) Further, the method described in (4) may be configured such that the insertion unit includes a plurality of air passages each including a recess-side opening that opens in the facing recess, the plurality of air passages being to be selectively used as the air supply passage including the air ejection outlet, the cutting assist device further includes a switching part configured to switch between the plurality of air passages to select at least one of the air passages used as the air supply passage; and in cutting the to-be-cut portion, the metal tubular member is cut while the switching part switches between the air passages to be used as the air supply passage as the cutting point is moved forward.
(6) Further, the method described in any one of (1) to (5) may be configured such that the laser beam is a near-infrared light, and the insertion unit includes a facing-recess constituting part made of cupper, which forms at least the facing recess.
(7) Another aspect of the disclosure to achieve the aforementioned purposes provides a method for manufacturing a power storage device incorporating the device case body manufactured in the method described in any one of (1) to (6).

### BRIEF DESCRIPTION OF THE DRAWINGS

FIG. 1 is a vertical cross-sectional view showing the structure of a battery in an embodiment;

FIG. 2 is a flowchart showing each step of manufacturing a battery in the embodiment and a modified embodiment;

FIG. 3 is a flowchart showing details of a case body forming step in the embodiment and the modified embodiment;

FIG. 4 is an explanatory diagram showing the structure of a cutting assist device i the embodiment;

FIG. 5 is a cross-sectional diagram taken along a line C-C in FIGS. 4 and 8, showing the configuration of an insertion unit in the embodiment and the modified embodiment;

FIG. 6 is an explanatory diagram showing that the insertion unit is inserted in a metal tubular member in the embodiment and the modified embodiment;

FIG. 7 is an explanatory diagram showing how to cut the metal tubular member in the embodiment and the modified embodiment;

FIG. 8 is an explanatory diagram showing how to suck suction air while cutting the metal tubular member in the embodiment;

FIG. 9 is an explanatory diagram showing the structure of a cutting assist device i the modified embodiment; and

FIG. 10 is an explanatory diagram showing how to blow out blowing air while cutting the metal tubular member in the modified embodiment.

### DETAILED DESCRIPTION OF THE EXEMPLARY EMBODIMENTS

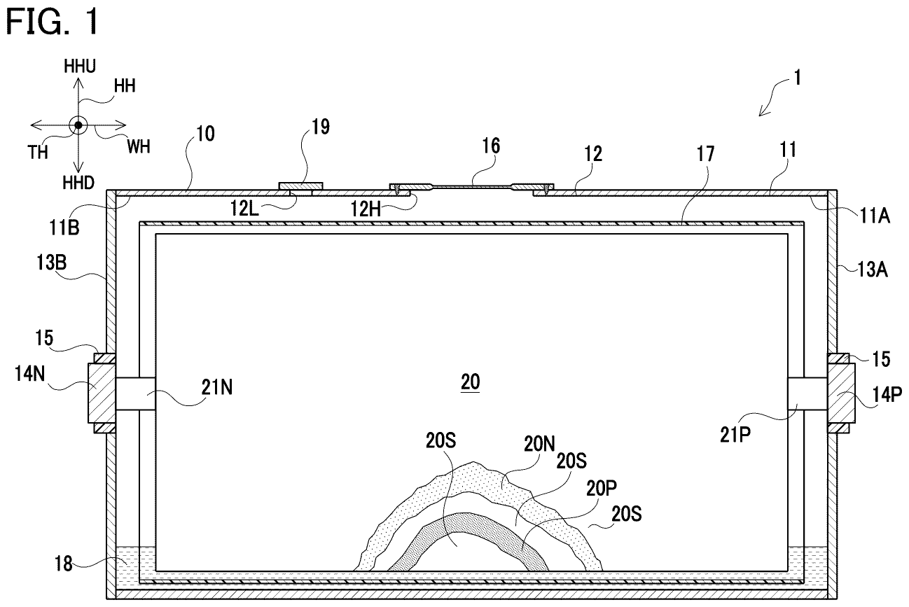

A detailed description of a battery 1 with a case body 11 according to an embodiment of the present disclosure will now be given referring to the accompanying drawings. The case body 11 is one example of a device case body of the present disclosure, ant the battery 1 is one example of a power storage device of the present disclosure. This battery 1 is a prismatic, sealed lithium ion-secondary battery, and can be mounted in vehicles, such as hybrid cars, plug-in hybrid cars, and electric vehicles, and various devices. Power storage devices with the case body 11 may include secondary batteries using ions of alkali metals, such as Na, K, Ca, or alkaline earth metals, as charge carriers, in addition to the lithium-ion secondary batteries, and further may include capacitors, such as lithium-ion capacitors. In the present embodiment, a width direction WH, a thick direction TH, a height direction HH, and an upper side HHU and a lower side HHD of the battery 1 are defined as shown in FIG. 1.

The battery 1 shown in FIG. 1 includes a battery case 10, an electrode body 20 hermetically housed in the battery case 10, an insulating film 17 interposed between the battery case 10 and the electrode body 20, and an electrolyte 18. The electrode body 20 is a flat wound electrode body formed from a strip-shaped positive electrode plate 20P and a strip-shaped negative electrode plate 20N, which are wound by alternately interposing two strip-shaped separators 20S and then pressurized into a flat shape. In the present embodiment, this electrode body 20 is placed in a sideways orientation with its wounding axis extending in the width direction WH (i.e., a horizontal direction in FIG. 1). The insulating film 17 serves to ensure electrical insulation between the electrode body 20 and the battery case 10. The electrolyte 18 is a known non-aqueous electrolyte.

The battery case 10 includes a case body 11 that is rectangular tube-shaped and has a rectangular first opening portion 11A and a rectangular second opening portion 11B, which are located on both ends in the width direction WH, a first lid member 13A that hermetically closes the first opening portion 11A, and a second lid member 13B that hermetically closes the second opening portion 11B, each of the lid members having a flat plate-like shape. The case body 11 and the two lid members 13A, 13B are each made of aluminum.

A positive current collector terminal 14P joined to a positive electrode tab 21P of the positive electrode plate 20P is fixed to the first lid member 13A via an insulating member 15. Similarly, a negative current collector terminal 14N joined to a negative electrode tab 21N of the negative electrode plate 20N is fixed to the second lid member 13B via an insulating member 15.

The case body 11 is made by cutting a metal tubular member 30 which will be mentioned later. This case body 11 has a rectangular tube shape with a rectangular cross-section, having two rectangular opening portions 11A and 11B on both sides in the width direction WH, and can internally house the electrode body 20. In the case body 11, a safety valve 16 closing a valve hole 12H is placed on an upper surface part 12 located on the upper side HHU. The safety valve 16 is configured to open the valve hole 12H when the internal pressure of the case body 11 exceeds a valve opening pressure.

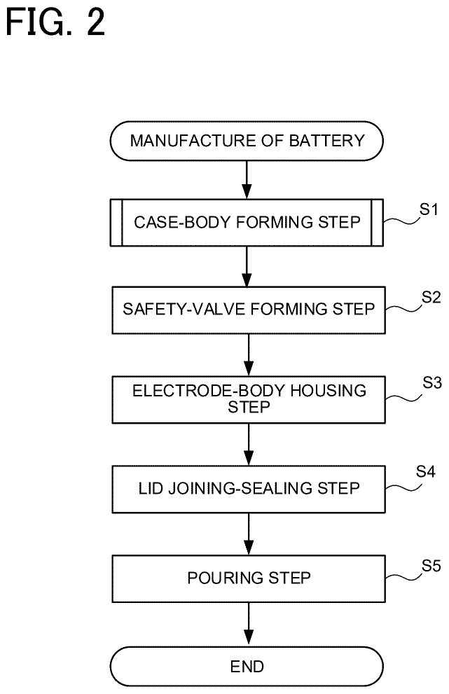

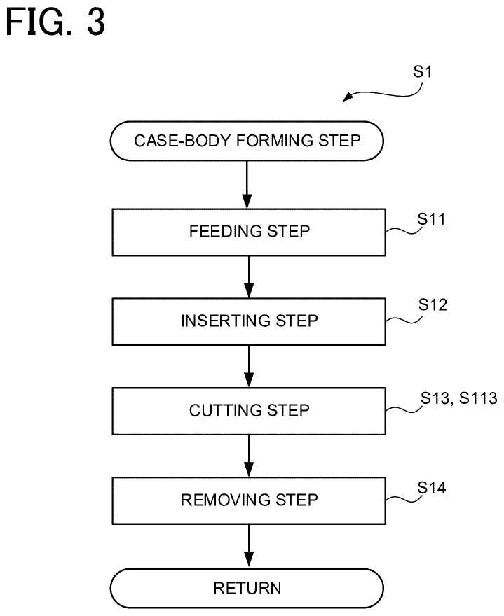

The method for manufacturing the battery 1 in the present embodiment includes a case-body forming step S1, a safety-valve forming step S2, an electrode-body housing step S3, a lid joining-sealing step S4, and a pouring step S5, as shown in FIG. 2. The case-body forming step S1 includes a feeding step S11, an inserting step S12, a cutting step S13, and a removing step S14, as shown in FIG. 3.

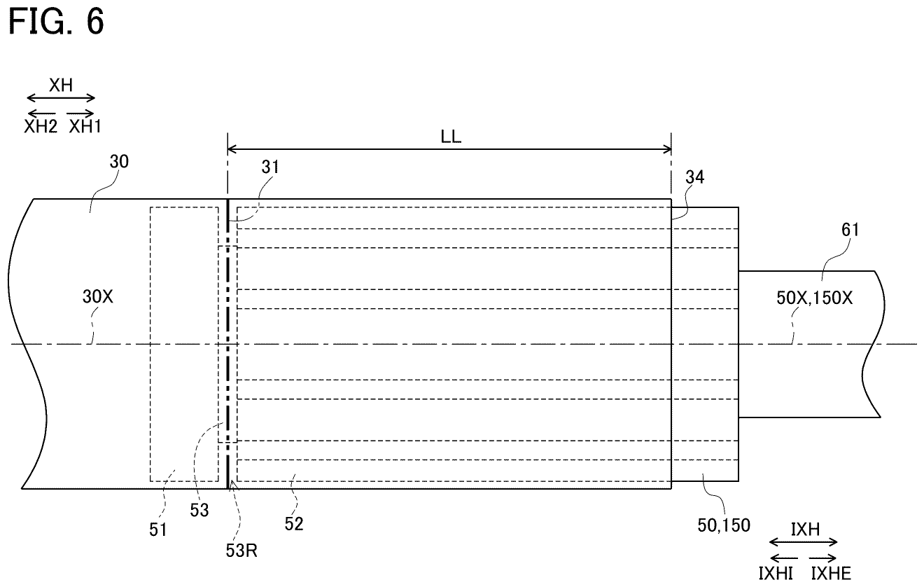

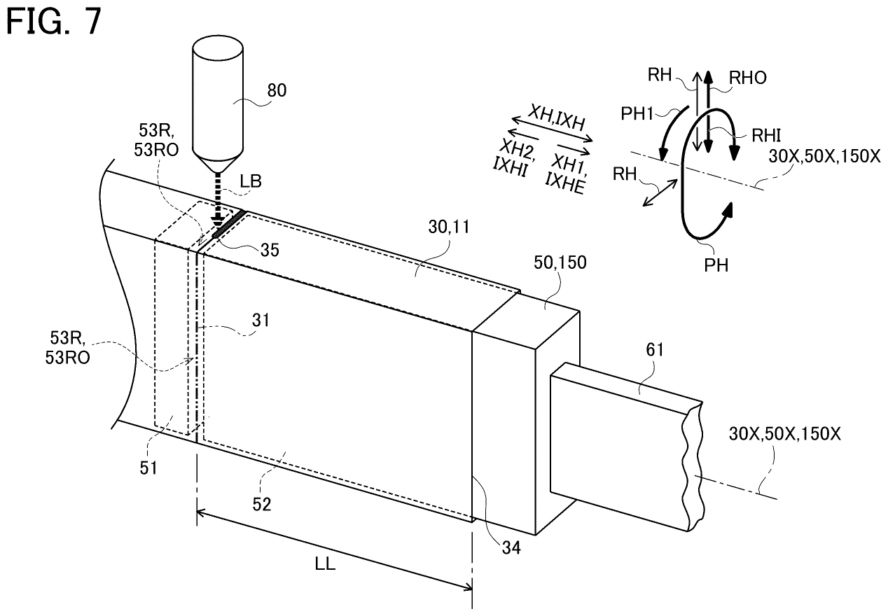

The case-body forming step S1 is a process of forming the case body 11 by cutting the metal tubular member 30, which is made of aluminum by extrusion in a long, hollow, rectangular tube shape extending in the axial direction XH along the axis 30X, as shown in FIGS. 6 and 7, at a portion to be cut (hereinafter, “a to-be-cut portion”) 31 set at intervals of a predetermined length LL and indicated by a thick double-dashed line. This to-be-cut portion 31 is virtually set as a ring-like pattern extending along the perimeter of the metal tubular member 30 in a circumferential direction PH around the axis 30X and at intervals of the predetermined length LL in the axial direction XH.

In the case-body forming step S1, every time the case body 11 is cut off, the feeding step S11 is performed to feed the metal tubular member 30 by the predetermined length LL corresponding to the length of the case body 11 in the axial direction XH, using a feeding device not shown, and hold the metal tubular member 30 in that position.

The inserting step S12 is performed to insert an insertion unit 50 of a cutting assist device 40 mentioned below into the metal tubular member 30 from its leading-end opening 34, which opens on the leading-end side XH1 (right side in FIG. 6 and lower right side in FIG. 7) in the axial direction XH, toward the base-end side XH2 (left side in FIG. 6 and upper left side in FIG. 7) until an insertion end part 51 mentioned below passes beyond the to-be-cut portion 31.

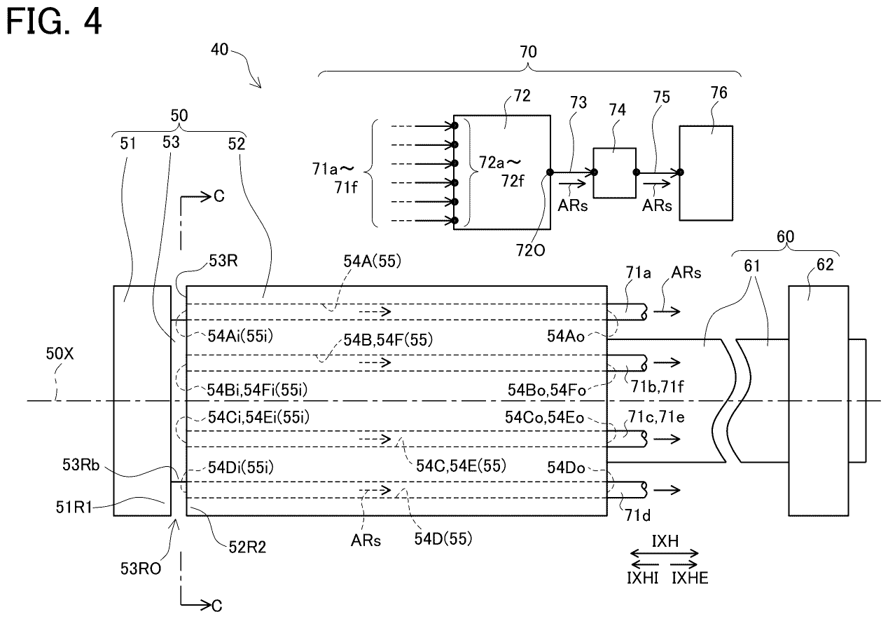

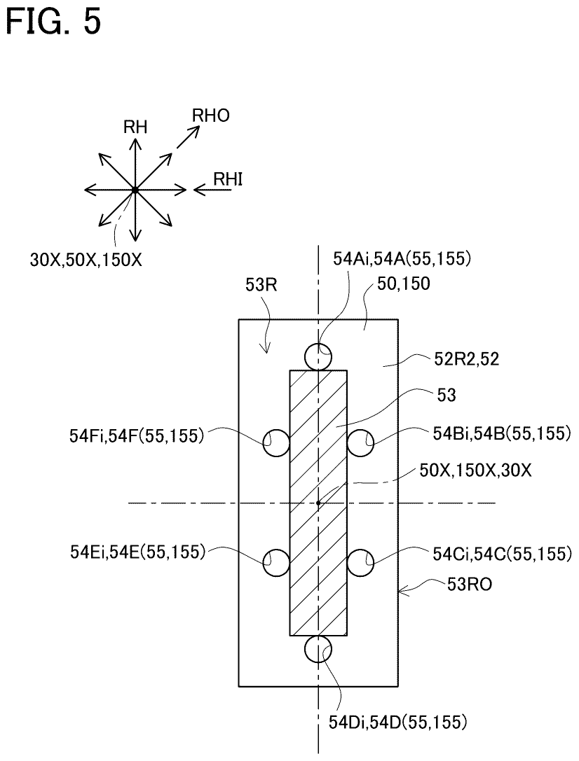

The cutting assist device 40 in the present embodiment includes the insertion unit 50 and further a moving mechanism 60 for moving the insertion unit 50 and an air suction unit 70 (see FIGS. 4 and 5). The insertion unit 50 has a roughly rectangular prismatic shape that is slightly smaller than the inner dimensions of the metal tubular member 30 so as to be insertable in the metal tubular member 30 (see FIGS. 6 and 7). The insertion unit 50 includes the insertion end part 51, which has a rectangular prismatic shape, on the inserting side IXHI in the axial direction IXH along the axis 50X of the insertion unit 50 (i.e., on the left side in FIG. 4), an insertion base portion 52, which has a rectangular prismatic shape and a longer length than the insertion end part 51 in the axial direction IXH, on the removing side IXHE of the insertion end part 51 (i.e., on the right side in FIG. 4), and further a recessed joint part 53 joining the insertion end part 51 and the insertion base portion 52. This recessed joint part 53 is designed with smaller dimensions in the radial directions RH perpendicular to the axis 50X than the insertion end part 51 and the insertion base portion 52, as shown in FIG. 5. Therefore, between the insertion end part 51 and the insertion base portion 52, a facing recess 53R is formed around the recessed joint part 53. This facing recess 53R has a rectangular ring frame-like shape, recessed toward the inside RHI in the radial directions RH. An outer open area of the facing recess 53R that opens circumferentially is referred to as a facing opening 53RO, which is placed to face the to-be-cut portion 31 in the cutting step S13 mentioned later. Furthermore, the facing recess 53R is also considered to be defined by a bottom portion 53Rb included in the recessed joint part 53, a first wall portion 51R1 included in the insertion end part 51, and a second wall portion 52R2 included in the insertion base portion 52.

In the present embodiment, the portions that form at least the facing recess 53R, that is, the bottom portion 53Rb of the recessed joint part 53, the first wall portion 51R1 of the insertion end part 51, and the second wall portion 52R2 of the insertion base portion 52, which constitute the facing recess 53R, are made of copper. Specifically, the entire insertion unit 50 is made of copper. As mentioned later, when the facing recess 53R receives a penetrating laser beam LBT that is a near-infrared light having a wavelength of about 1046 nm, emitted from a laser device 80 composed of a fiber laser, the copper forming the insertion unit 50 can absorb the laser beam and suppress stray light, and further exhibit higher heat resistance and excellent thermal conductivity, as compared with aluminum. This configuration can suppress damages to those bottom portion 53Rb, first wall portion 51R1, and second wall portion 52R2, which constitute the facing recess 53R, due to irradiation of the penetrating laser beam LBT.

The moving mechanism 60 for moving the insertion unit 50 includes, as shown in FIG. 4, an insertion-part retaining part 61 extending from the insertion unit 50 toward the removing side IXHE (right side in FIG. 4), and a moving part 62 for moving the insertion-part retaining part 61 and the insertion unit 50 in the axial direction IXH.

In the inserting step S12, the insertion unit 50 is inserted in the metal tubular member 30 by moving the insertion-part retaining part 61 and the insertion unit 50 toward the inserting side IXHI by the moving part 62 so that the insertion end part 51 of the insertion unit 50 inserted from the leading-end opening 34 passes beyond the to-be-cut portion 31 virtually determined on the metal tubular member 30 as shown in FIGS. 6 and 7, until the facing opening 53RO of the facing recess 53R reaches a position to face the to-be-cut portion 31. In other words, the ring-shaped facing opening 53RO of the facing recess 53R is placed to face the to-be-cut portion 31 of the metal tubular member 30.

In the present embodiment, additionally, six air passages 54A to 54F, each extending in a right circular cylinder shape, are provided in the insertion base portion 52 of the insertion unit 50. The ends of the air passages 54A to 54F on the inserting side IXHI respectively open as recess-side openings 54Ai to 54Fi in the second wall portion 52R2 forming the facing recess 53R. In contrast, the other ends of the air passages 54A to 54F on the removing side IXHE respectively open as retaining-part-side openings 54Ao to 54Fo on the side facing the insertion-part retaining part 61 and are connected to six air pipes 71a to 71f of the air suction unit 70.

The air suction unit 70 includes, as shown in FIG. 4, the six air pipes 71a to 71f, a port switching part 72, a filter 74, an air suction pump 76, and air suction pipes 73 and 75 that connect those components. The six air pipes 71a to 71f are respectively connected to six air suction ports 72a to 72f of the port switching part 72. The port switching part 72 is connected, at its air exhaust port 72O, to one end of a single air suction pipe 73. The other end of this air suction pipe 73 is connected to the air suction pump 76 via the filter 74 and the air suction pipe 75. The air suction pump 76 serves to draw in suction air ARs. The filter 74 is a filter for filtering out spatter particles SP contained in the suction air ARs, as described later. The port switching part 72 has the function of switching between the six air suction ports 72a to 72f to connected to the single air exhaust port 72O to form an air circuit.

In the present embodiment, therefore, the suction air ARs is allowed to flow in the air pipe connected to the air suction port(s) selected from among the six air suction ports 72a to 72f by the port switching part 72, and further the corresponding air passage(s) in the insertion base portion 52, which is connected to the relevant air pipe(s). In other words, at least one of the six air passages 54A to 54F respectively having the recess-side openings 54Ai to 54Fi is used as an air suction passage 55 having an air suction inlet 55i opening in the facing recess 53R and allowing the suction air ARs to flow therethrough via the air suction inlet 55i.

In the subsequent cutting step S13, as shown in FIG. 7, the metal tubular member 30 is circumferentially cut in a ring-like shape by irradiation of the laser beam LB applied from the outside RHO in the radial direction RH (i.e., one side PH1 in the circumferential direction PH) along the to-be-cut portion 31 indicated by the thick double-dashed line to the to-be-cut portion 31, using the laser device 80 (in the present embodiment, the fiber laser having a wavelength of 1046 nm is employed), thereby obtaining the case body 11. Prior to this cutting step S13, the insertion unit 50 is inserted in advance in the metal tubular member 30 in the inserting step S12, as described above.

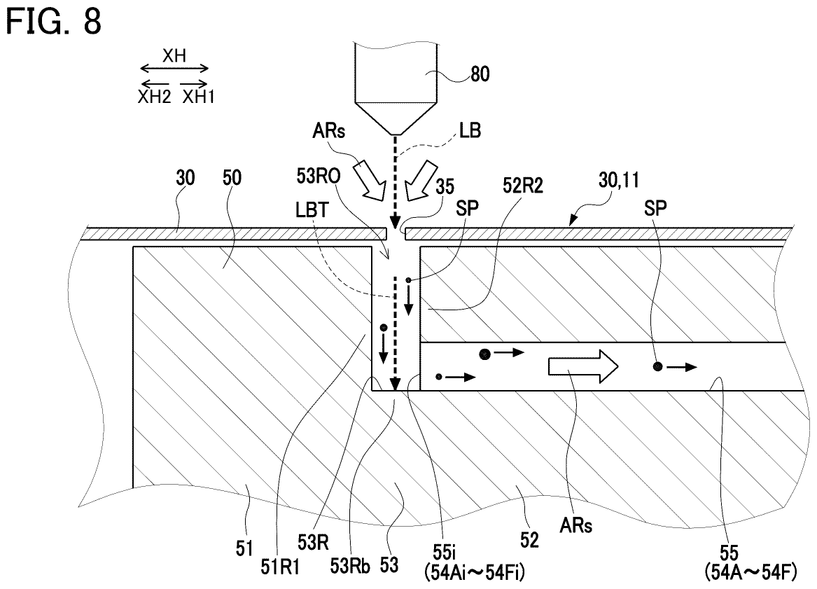

Accordingly, as shown in FIG. 8, while one side surface of the metal tubular member 30 is being cut by irradiation of the laser beam LB, the penetrating laser beam LBT passing through the cutting point 35 is received by the facing recess 53R of the insertion unit 50, and thus does not reach the inner peripheral surface of the opposite side surface of the metal tubular member 30. It is therefore possible to prevent damages, such as melt marks caused by incidence of the penetrating laser beam LBT on the inner peripheral surfaces of the case body 11 or the metal tubular member 30 near the both opening portions 11A, 11B. Thus, this method can suppress defects, such as damages to the electrode body 20, from occurring for example when the electrode body 20 is inserted in the case body 11.

Moreover, the insertion unit 50 in the present embodiment includes the air suction passages 55 including the air suction inlets 55i that open in the facing recess 53R and allowing the suction air ARs drawn through the selected air suction inlet(s) 55i from around the cutting point 35 under being cut by the laser beam LB, to flow in the air suction passage(s) 55. The cutting assist device 40 in the present embodiment further includes the air suction unit 70 for sucking the suction air ARs via the selected air suction passage(s) 55 of the insertion unit 50. In the cutting step S13, as shown in FIG. 8, while the metal tubular member 30 is being cut, the spatter particles SP generated at the cutting point 35 are sucked together with the suction air ARs to the air suction unit 70 via the air suction passage(s) 55. This can reduce the possibilities that the spatter particles SP remain in and stick to the inside of the manufactured case body 11, and hence the spatter particles SP remain inside the battery 1.

In addition, the insertion unit 50 in the present embodiment includes the six air passages 54A to 54F respectively including the recess-side openings 54Ai to 54Fi, each of which opens in the facing recess 53R and serves as the air suction passage 55 including the air suction inlet 55i. The cutting assist device 40 further includes the port switching part 72 for switching between the six air passages 54A to 54F to be used as the air passage to flow the suction air ARs, that is, selecting at least one of the air passages 54A to 54F as the air suction passage(s)55. In the cutting step S13 in the present embodiment, therefore, the metal tubular member 30 is being cut by switching between the air passages 54A to 54F to be used as the air suction passage(s) 55 by the port switching part 72 according to forward movement of the cutting point 35.

Since the air passages 54A to 54F are switched to serve as the air suction passage(s) 55 according to forward movement of the cutting point 35 as described above, it is possible to suppress significant variations in suction strength even if the cutting point 35 moves as the cutting progresses, thus ensuring that the spatter particles SP are appropriately sucked into the air suction unit 70 (specifically, the filter 74), suppressing the spatter particles SP from remaining in and sticking to the inside of the manufactured case body 11.

Specifically, as the cutting point 35 moves forward on the to-be-cut portion 31 by irradiation of the laser beam LB, the port switching part 72 operates to select one or two of the air suction ports 72a to 72f to be connected to the air exhaust port 72O so that one or two of the recess-side openings 54Ai to 54Fi, near the cutting point 35, are used as the air suction inlet or inlets 55i, and one or two of the air passages 54A to 54F including the corresponding recess-side opening or openings 54Ai to 54Fi are used the air suction passage or passage(s) 55. For example, at the timing when the cutting point 35 is at the position shown in FIG. 7, the port switching part 72 operates to connect the air suction port 72a to the air exhaust port 72O to use the recess-side opening 54Ai as the air suction inlet 55i and the air passage 54A as the air suction passage 55.

In the cutting step S13, after the metal tubular member 30 is cut to a length of one case body 11, the removing step S14 is performed to remove, i.e., pull out, the insertion end part 51 of the insertion unit 50 from the metal tubular member 30 (see FIG. 3). Specifically, the insertion-part retaining part 61 and the insertion unit 50 are moved toward the removing side IXHE (right side in FIG. 6, lower right side in FIG. 7) by the moving part 62. Thereafter, the case body 11 manufactured as above is removed from the insertion unit 50 using a robot or other device for separating, i.e., sliding out, the case body 11 by inclining the insertion-part retaining part 61 and the insertion unit 50.

In the safety-valve forming step S2, thereafter, the valve hole 12H and a liquid inlet 12L are formed in the upper surface part 12 of the case body 11, and the safety valve 16 produced in advance is welded to the upper surface part 12 to close the valve hole 12H.

In advance, the negative current collector terminal 14N of the second lid member 13B is connected to the negative electrode plate 20N of the electrode body 20 with the negative electrode tab 21N. Further, the insulating film 17 is wrapped around the electrode body 20 connected to the second lid member 13B. In the electrode-body housing step S3, this electrode body 20 is housed in the case body 11, and the second lid member 13B is placed to close the second opening portion 11B of the case body 11. Subsequently, the positive current collector terminal 14P of the first lid member 13A is connected to the positive electrode plate 20P of the electrode body 20 with the positive electrode tab 21P, and the first lid member 13A is placed to close the first opening portion 11A of the case body 11.

In the following lid joining-sealing step S4, the first lid member 13A is hermetically welded to the first opening portion 11A of the case body 11 over its entire circumference by laser. Similarly, the second lid member 13B is hermetically welded to the second opening portion 11B of the case body 11 over its entire circumference by laser. Thus, the battery case 10 is formed.

In the pouring step S5, subsequently, the electrolyte 18 is poured into the battery case 10 through the liquid inlet 12L formed in advance in the upper surface part 12 of the case body 11, and then an inlet stopper 19 is welded to the upper surface part 12 to hermetically close the liquid inlet 12L. The battery case 10 is thus hermetically sealed. This battery case 10 is subjected to subsequent processes, such as known initial charging, high-temperature aging, and various inspections, completing the battery 1.

The above-described manufacturing method for the battery 1 can employ the tubular case body 11 with no defects, such as melt marks, in the inner peripheral surface, and thus manufacture the battery 1 while suppressing damages to the electrode body 20, which may occur when the electrode body 20 is put into the case body 11. In the manufacturing method for the battery 1 in the present embodiment, the generated spatter particles SP are sucked by the air suction unit 70 together with the suction air ARs through the air suction passage(s) 55. This method can therefore suppress the spatter particles SP from staying inside the case body 11 and hence remaining inside the battery 1.

### Modified Embodiments

Next, a modified embodiment of the manufacturing method for the battery 1 will be described below. In the above-described embodiment, in the cutting step S13, the metal tubular member 30 is cut by the laser beam LB and simultaneously the generated spatter particles SP are sucked by the air suction unit 70 together with the suction air ARs through the air suction passage(s) 55.

In contrast, the present modified embodiment differs from the foregoing embodiment only in a cutting step S113 wherein the metal tubular member 30 is cut by the laser beam LB and simultaneously the generated spatter particles SP are expelled out of the metal tubular member 30 by blowing air ARb ejected through an air supply passage(s) 155 provided in an insertion unit 150. Accordingly, the following description will be given with a focus on the differences from the foregoing embodiment and similar or identical parts are omitted or simplified.

A cutting assist device 140 in the present modified embodiment includes the insertion unit 150, and the moving mechanism 60 similar to that in the foregoing embodiment to move the insertion unit 150, and additionally an air supply unit 170 (see FIGS. 4 and 5), instead of the air suction unit 70 of the foregoing embodiment. The insertion unit 150 is similar to the insertion unit 50 in the foregoing embodiment and is also similarly configured such that six air passages 54A to 54F, each extending in a right circular cylinder shape, are provided in the insertion base portion 52, and the ends of the air passages 54A to 54F on the inserting side IXHI respectively open as recess-side openings 54Ai to 54Fi in the second wall portion 52R2 forming the facing recess 53R. Also similar to the foregoing embodiment, the retaining-part-side openings 54Ao to 54Fo, which are the ends of the air passages 54A to 54F on the removing side IXHE, are respectively connected to six air pipes 71a to 71f. In the insertion unit 150 in the present modified embodiment, however, the six right circular cylinder-shaped passages 54A to 54F are used as the air supply passage(s) 155, not as the air suction passage(s) 55.

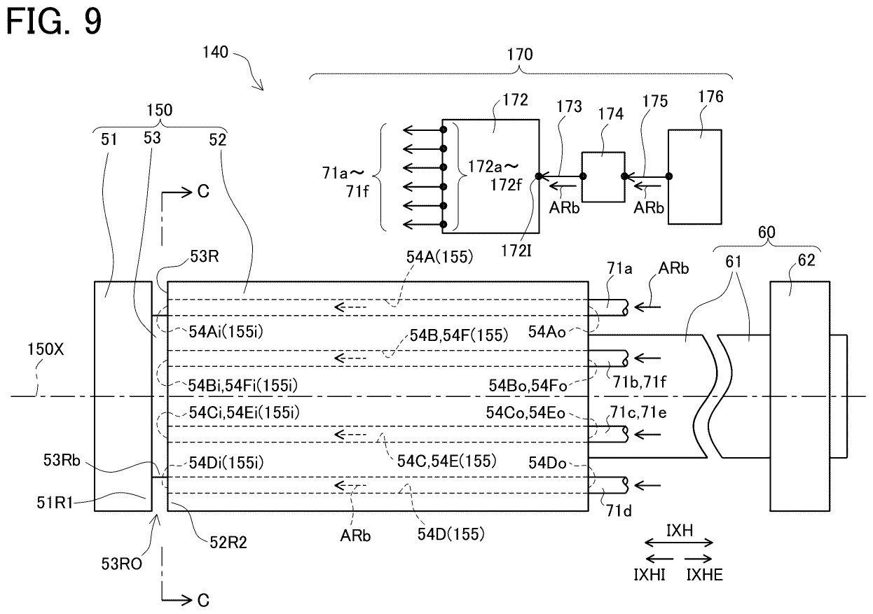

In the cutting assist device 140 in the present modified embodiment, the air supply unit 170 includes the six air pipes 71a to 71f as in the foregoing embodiment, a port switching part 172, a filter 174, an air supply pump 176, and air supply pipes 173 and 175 that connect those components, as shown in FIG. 9. The blowing air ARb supplied from the air supply pump 176 reaches the filter 174 via the air supply pipe 175. The blowing air ARb, from which oil and others are removed by the filter 174, is fed into the port switching part 172 through an air feed port 172I, and distributed to the six air pipes 71a to 71f respectively connected to the six air supply ports 172a to 172f. The port switching part 172 in the present modified embodiment also has the function of switching between the six air supply ports 172a to 172f to be connected to the single air feed port 172I to form an air circuit.

In the present modified embodiment, therefore, the blowing air ARb is supplied to the air pipe connected to the air supply port(s) selected from among the six air supply ports 172a to 172f by the port switching part 172, and further the air passage(s) in the insertion base portion 52 connected to the selected air supply port(s). In other words, at least one of the six air passages 54A to 54F respectively having the recess-side openings 54Ai to 54Fi is used as the air supply passage 155 having the air ejection outlet 155i opening in the facing recess 53R and allowing the blowing air ARb to flow therethrough via the air ejection outlet 155i.

In the subsequent cutting step S113, as shown in FIG. 7, the metal tubular member 30 is circumferentially cut in a ring-like shape by irradiation of the laser beam LB applied from the outside RHO in the radial direction RH along the to-be-cut portion 31 indicated by the thick double-dashed line to the to-be-cut portion 31, using the laser device 80 (also in the present modified embodiment, the fiber laser having a wavelength of 1046 nm is employed), thereby obtaining the case body 11. Prior to this cutting step S113, the insertion unit 150 is inserted in advance in the metal tubular member 30 in the inserting step S12, as described above.

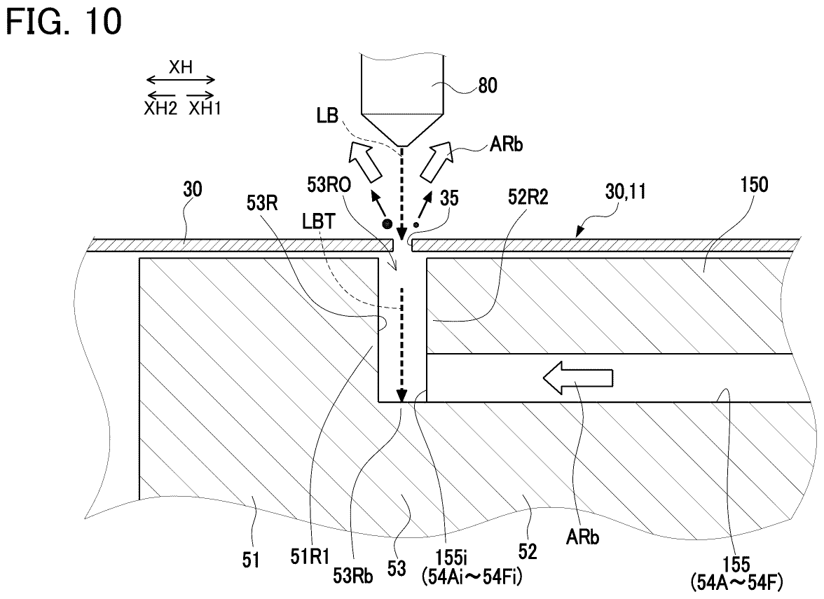

Accordingly, as shown in FIG. 10, while one side surface of the metal tubular member 30 is being cut by irradiation of the laser beam LB, the penetrating laser beam LBT passing through the cutting point 35 is received by the facing recess 53R of the insertion unit 150, and does not reach the inner peripheral surface of the opposite side surface of the metal tubular member 30. It is therefore possible to prevent damages, such as melt marks caused by the penetrating laser beam LBT on the inner peripheral surface of the case body 11 near the both opening portions 11A, 11B. Thus, this method can suppress defects, such as damages to the electrode body 20, from occurring for example when the electrode body 20 is inserted in the case body 11.

Moreover, the insertion unit 150 in the present modified embodiment includes the air supply passages 155 including the air ejection outlets 155i that open in the facing recess 53R and allowing the blowing air ARb to be ejected through the selected air ejection outlet(s) 155i out of the metal tubular member 30 via the surrounding of the cutting point 35 under being cut by the laser beam LB. The cutting assist device 140 further includes the air supply unit 170 for supplying the blowing air ARb via the selected air supply passage(s) 155 of the insertion unit 150. In the cutting step S113, as shown in FIG. 10, while the metal tubular member 30 is being cut, the spatter particles SP generated at the cutting point 35 are expelled out of the metal tubular member 30 by the blowing air ARb ejected through the air supply passage(s) 155. This can reduce the possibilities that the spatter particles SP remain in and stick to the inside of the manufactured case body 11, and hence the spatter particles SP remain inside the battery 1.

In addition, the insertion unit 150 in the present modified embodiment includes the six air passages 54A to 54F respectively including the recess-side openings 54Ai to 54Fi, each of which opens in the facing recess 53R and serves as the air supply passage 155 including the air ejection outlet 155i. The cutting assist device 140 further includes the port switching part 172 for switching between the six air passages 54A to 54F to be used as the air supply passage 155, that is, selecting at least one of the air passages 54A to 54F. In the cutting step S113 in the present modified embodiment, therefore, the metal tubular member 30 is being cut by switching between the air passages 54A to 54F to be used as the air supply passage(s) 155 by the port switching part 172 according to the forward movement of the cutting point 35.

Since the air passages 54A to 54F are switched to serve as the air supply passage(s) 155 according to forward movement of the cutting point 35 as described above, it is possible to suppress lowering of the blowing strength even if the cutting point 35 moves as the cutting progresses, thus ensuring that the spatter particles SP are appropriately expelled out of the metal tubular member 30, suppressing the spatter particles SP from remaining in and sticking to the inside of the manufactured case body 11.

Specifically, as the cutting point 35 moves forward on the to-be-cut portion 31 by irradiation of the laser beam LB, the port switching part 172 operates to select one or two of the air supply ports 172a to 172f to be connected to the air feed port 172I so that one or two of the recess-side openings 54Ai to 54Fi, near the cutting point 35, are used as the air ejection outlet or outlets 155i, and one or two of the air passages 54A to 54F including the selected one(s) of the recess-side openings 54Ai to 54Fi are used as the air supply passage(s) 155. For example, at the timing when the cutting point 35 is at the position shown in FIG. 7, the port switching part 172 operates to connect the air supply port 172a to the air feed port 172I to use the recess-side opening 54Ai as the air ejection outlet 155i and the air passage 54A as the air supply passage 155. Through subsequent processes identical to those in the embodiment, the battery 1 is manufactured.

The disclosure is described in the foregoing embodiment and modified embodiment, but is not limited to the embodiment and others. The disclosure may be embodied in other specific forms without departing from the essential characteristics thereof.

In the embodiment, for example, the moving mechanism 60 is used in the inserting step S12 to move the insertion unit 50 toward the inserting side IXHI and insert the insertion unit 50 into the metal tubular member 30. As an alternative configuration, the insertion unit 50 may be fixed, and the metal tubular member 30 may be moved so that the insertion unit 50 is inserted in the metal tubular member 30. As another alternative configuration, both the insertion unit 50 and the metal tubular member 30 may be moved to insert the insertion unit 50 into the metal tubular member 30. In those cases, the feeding step for feeding the metal tubular member 30 and the inserting step for inserting the metal tubular member 30 may be performed at the same time.

The material of the insertion unit 50 may be selected from metal materials, such as the copper mentioned above and aluminum, and ceramic materials, such as alumina. The laser device can be selected according to the material and the thickness of the metal tubular member to be cut, and other conditions, and may include, for example, a fiber laser that generates a near-infrared light with a wavelength of about 1000 nm, a YAG laser, a CO2 laser that generates a far-infrared light with a wavelength of about battery case 10μm, and so on.

### Reference Signs List

1 Battery (Power storage device)
11 Case body (Device case body)
20 Electrode body
30 Metal tubular member
30x Axis (of metal tubular member)
XH Axial direction (of metal tubular member)
XH1 Leading-end side
XH2 Base-end side
PH Circumferential direction
PH1 One side (of circumferential direction)
RH Radial direction
RHO Outside
RHI Inside
31 To-be-cut portion
34 Leading-end opening
35 Cutting point
40, 140 Cutting assist device
50, 150 Insertion part
50X, 150X Axis (of insertion unit)
53R Facing recess
53RO Facing opening
54A to 54F Air passage
54Ai to 54Fi Recess-side opening (of air passage)
55 Air suction passage
55i Air suction inlet
155 Air supply passage
155i Air ejection outlet
ARs Suction air
ARb Ejection air
70 Air suction part
170 Air supply part
72, 172 Port switching part (Switching part)
LB Laser beam
LBT Penetrating laser beam
SP Spatter particles
S1 Case-body forming step
S12 Inserting step
S13, S113 Cutting step
S3 Electrode-body housing step (Housing step)
S4 Lid joining-sealing step (Joining-sealing step)

What is claimed is:

1. A method for manufacturing a device case body, which is made of metal in a tubular shape and used for a power storage device, the method comprising:
inserting an insertion unit of a cutting assist device into a metal tubular member having a hollow tubular shape extending in an axial direction along an axis of the metal tubular member, through a leading-end opening that opens on a leading end side of the metal tubular member, beyond a to-be-cut portion of the metal tubular member, the to-be-cut portion extending in a ring shape in a circumferential direction around the axis;
cutting the to-be-cut portion by irradiating a laser beam from outside in a radial direction of the metal tubular member onto the to-be-cut portion to obtain the device case body; and
removing the insertion unit from the metal tubular member after the device case body is cut by cutting the to-be-cut portion,
wherein the insertion unit includes a facing recess that is recessed to an inside of the insertion unit in the radial direction and that includes a facing opening extending in a ring shape and facing the to-be-cut portion of the metal tubular member, and
in cutting the to-be-cut portion, the metal tubular member is cut while a penetrating laser beam that penetrates through the metal tubular member is received by the facing recess.

2. The method for manufacturing the device case body according to claim 1, wherein
the insertion unit includes an air suction passage including an air suction inlet that opens in the facing recess and allowing suction air to flow through, the suction air being sucked from an area around a cutting point via the facing recess and the air suction inlet, while the cutting point is being cut by irradiation of the laser beam,
the cutting assist device includes an air suction unit to suck the suction air through the air suction passage of the insertion unit, and
in cutting the to-be-cut portion, the metal tubular member is cut while spatter particles occurring from the cutting point are sucked by the air suction unit together with the suction air through the air suction passage.

3. The method for manufacturing the device case body according to claim 2, wherein
the insertion unit includes a plurality of air passages each including a recess-side opening that opens in the facing recess, the plurality of air passages being to be selectively used as the air suction passage including the air suction inlet,
the cutting assist device further includes a switching part configured to switch between the plurality of air passages to select at least one of the air passages used as the air suction passage, and
in cutting the to-be-cut portion, the metal tubular member is cut while the switching part switches between the air passages to be used as the air suction passage as the cutting point is moved forward.

4. The method for manufacturing the device case body according to claim 1, wherein
the insertion unit includes an air supply passage including an air ejection outlet that opens in the facing recess and allowing blowing air to flow through, the blowing air being to be ejected from the air ejection outlet to an outside of the metal tubular member via the facing recess and an area around the cutting point, while the cutting point is being cut by irradiation of the laser beam,
the cutting assist device includes an air supply unit to supply the blowing air through the air supply passage of the insertion unit, and
in cutting the to-be-cut portion, the metal tubular member is cut while spatter particles occurring from the cutting point are expelled out of the metal tubular member by the blowing air ejected through the air supply passage.

5. The method for manufacturing the device case body according to claim 4, wherein
the insertion unit includes a plurality of air passages each including a recess-side opening that opens in the facing recess, the plurality of air passages being to be selectively used as the air supply passage including the air ejection outlet,
the cutting assist device further includes a switching part configured to switch between the plurality of air passages to select at least one of the air passages used as the air supply passage; and
in cutting the to-be-cut portion, the metal tubular member is cut while the switching part switches between the air passages to be used as the air supply passage as the cutting point is moved forward.

6. The method for manufacturing the device case body according to claim 1,
wherein the laser beam is a near-infrared light, and
the insertion unit includes a facing-recess constituting part made of cupper, which forms at least the facing recess.

7. The method for manufacturing the device case body according to claim 2,
wherein the laser beam is a near-infrared light, and
the insertion unit includes a facing-recess constituting part made of cupper, which forms at least the facing recess.

8. The method for manufacturing the device case body according to claim 3,
wherein the laser beam is a near-infrared light, and
the insertion unit includes a facing-recess constituting part made of cupper, which forms at least the facing recess.

9. The method for manufacturing the device case body according to claim 4,
wherein the laser beam is a near-infrared light, and
the insertion unit includes a facing-recess constituting part made of cupper, which forms at least the facing recess.

10. The method for manufacturing the device case body according to claim 5,
wherein the laser beam is a near-infrared light, and
the insertion unit includes a facing-recess constituting part made of cupper, which forms at least the facing recess.

11. A method for manufacturing a power storage device, the method comprising:
housing an electrode body in the device case body manufactured by the device case body manufacturing method according to claim 1; and
joining and sealing a lid member to the device case body with the electrode body housed.

12. A method for manufacturing the power storage device, the method comprising:
housing an electrode body in the device case body manufactured by the device case body manufacturing method according to claim 2; and
joining and sealing a lid member to the device case body with the electrode body housed.

13. A method for manufacturing the power storage device, the method comprising:
housing an electrode body in the device case body manufactured by the device case body manufacturing method according to claim 3; and
joining and sealing a lid member to the device case body with the electrode body housed.

14. A method for manufacturing the power storage device, the method comprising:
housing an electrode body in the device case body manufactured by the device case body manufacturing method according to claim 4; and
joining and sealing a lid member to the device case body with the electrode body housed.

15. A method for manufacturing the power storage device, the method comprising:
housing an electrode body in the device case body manufactured by the device case body manufacturing method according to claim 5; and
joining and sealing a lid member to the device case body with the electrode body housed.

16. A method for manufacturing the power storage device, the method comprising:
housing an electrode body in the device case body manufactured by the device case body manufacturing method according to claim 6; and
joining and sealing a lid member to the device case body with the electrode body housed.

17. A method for manufacturing the power storage device, the method comprising:
housing an electrode body in the device case body manufactured by the device case body manufacturing method according to claim 7; and
joining and sealing a lid member to the device case body with the electrode body housed.

18. A method for manufacturing the power storage device, the method comprising:
housing an electrode body in the device case body manufactured by the device case body manufacturing method according to claim 8; and
joining and sealing a lid member to the device case body with the electrode body housed.

19. A method for manufacturing the power storage device, the method comprising:
housing an electrode body in the device case body manufactured by the device case body manufacturing method according to claim 9; and
joining and sealing a lid member to the device case body with the electrode body housed.

20. A method for manufacturing the power storage device, the method comprising:
housing an electrode body in the device case body manufactured by the device case body manufacturing method according to claim 10; and
joining and sealing a lid member to the device case body with the electrode body housed.
